(19) United States
(12) Patent Application Publication
(10) Pub. No.: US 2005/0275904 A1
(43) Pub. Date: Dec. 15, 2005

(54) Image capturing apparatus and program

(75) Inventors: Toshihito Kido, Matsubara-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 10/917,050

(22) Filed: Aug. 12, 2004

(30) Foreign Application Priority Data
May 25, 2004 (JP) JP2004-154781

(51) Int. Cl. G06K 9/40

(52) U.S. Cl. 358/461; 382/274

(57) ABSTRACT

Shading occurring in an image captured by an image sensor has a characteristic in that the light amount decrease ratio is asymmetrical with respect to the center of the image and varies according to a color component. Consequently, three correction tables are generated in correspondence with three color component images of R, G and B which form a color un-corrected image. The correction tables have correction factors whose values are asymmetrical with respect to the center of an image. By using the dedicated correction tables for the three color component images of the un-corrected image, shading correction is made. Thus, shading in the un-corrected image is properly corrected.

This application is based on application No. 2004-154781 filed in Japan, the contents of which are hereby incorporated by reference.

### BACKGROUND OF THE INVENTION

1. Field of the Invention

The present invention relates to a technique of correcting shading in an image captured by an image sensor.

2. Description of the Background Art

In an image captured by an image capturing apparatus such as a digital camera, a phenomenon of decrease in a peripheral light amount called shading occurs. A part of the shading occurs due to the characteristics of an image sensor.

In an image sensor as a collection of fine light sensing pixels, a microlens as a condenser lens is disposed for each of the light sensing pixels. In an image capturing apparatus of recent years strongly demanded to be miniaturized, generally, telecentricity on an image side is low and the incident angle of light increases toward the periphery of the image sensor. Consequently, when the incident angle increases, the condensing position of a light beam by a microlens is deviated from the center of a photosensitive face of a light sensing pixel, and the light reception amount of the light sensing pixel decreases. As a result, shading occurs in the peripheral portion of an image.

Hitherto, a technique is known that the microlenses are disposed near to the optical axis side of an image capturing optical system rather than the positions just above the light sensing pixels in order to suppress sensor system shading which occurs due to the characteristics of the image sensor.

Such sensor system shading has various characteristics. For example, the light amount decrease ratio of the sensor system shading is asymmetrical with respect to the center of an image (position corresponding to the optical axis) on the basis of a manufacture error and the like of the image sensor. Since dispersion occurs in the microlens, the light amount decrease ratio of the sensor system shading varies according to colors.

As described above, the sensor system shading has various characteristics. However, a shading correcting technique considering such characteristics has not been conventionally proposed, and shading in an image captured by the image sensor cannot be properly corrected.

### SUMMARY OF THE INVENTION

The present invention is directed to an image capturing apparatus.

According to the present invention, the image capturing apparatus comprises: an image capturing optical system; an image sensor having a plurality of light sensing pixels for photoelectrically converting a light image formed by the image capturing optical system; and a corrector for correcting shading in an image made of a plurality of pixels in a two-dimensional array captured by the image sensor by using a plurality of correction factors corresponding to the plurality of pixels. Values of the plurality of correction factors are asymmetrical with respect to a position corresponding to an optical axis of the image capturing optical system.

Since shading is corrected by using correction factors whose values are asymmetrical with respect to the position corresponding to the optical axis of the image capturing optical system, shading in an image can be properly corrected.

According to an aspect of the present invention, the corrector makes the shading correction by using first correction data including a correction factor for correcting shading which occurs due to characteristics of the image sensor.

Thus, shading which occurs due to the characteristics of the image sensor can be properly corrected.

According to another aspect of the present invention, the corrector makes the shading correction by also using second correction data including a correction factor for correcting shading which occurs due to characteristics of the image capturing optical system.

Consequently, shading which occurs due to the characteristics of the image capturing optical system can be properly corrected.

The present invention is also directed to a method of correcting shading in an image capturing apparatus.

The present invention is also directed to a computer-readable computer program product.

Therefore, an object of the present invention is to provide a technique capable of properly correcting shading in an image captured by an image sensor.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the relation between an image sensor and the optical axis of an image capturing optical system;

FIGS. 2 to 5 are cross-sectional views of a portion around a light sensing pixel in the image sensor;

FIG. 6 is a perspective view of a digital camera;

FIG. 7 is a diagram showing the configuration of a rear side of the digital camera;

FIG. 8 is a block diagram schematically showing the functional configuration of the digital camera;

FIG. 9 is a diagram showing an image in which a rectangular coordinate system is set;

FIG. 10 is a diagram showing an example of values of axial factors on the X axis included in first correction data;

FIG. 11 is a diagram showing an example of values of axial factors on the Y axis included in the first correction data;

FIG. 12 is a diagram showing an example of values of axial factors included in second correction data;

FIG. 13 is a diagram showing the flow of basic operations in an image capturing mode;

FIG. 14 is a diagram showing functions related to a shading correcting process;

FIG. 15 is a diagram showing the flow of the shading correcting process;

FIG. 16 is a diagram showing an example of values of axial factors on the Y axis included in the first correction data;

FIG. 17 is a diagram showing an image on which an oblique coordinate system is set;

FIG. 18 is a diagram showing an example of values of axial factors included in the first correction data;

FIG. 19 is a diagram showing an example of values of axial factors included in second correction data;

FIG. 20 is a diagram showing a computer for correcting shading; and

FIGS. 21 and 22 are cross-sectional views showing a portion around a light sensing pixel in a peripheral portion of an image sensor.

### DESCRIPTION OF THE PREFERRED EMBODIMENTS

In the specification, pixels as basic elements constructing an image sensor will be referred to as “light sensing pixels” and pixels as basic elements constructing an image will be simply referred to as “pixels”.

1. Shading

Prior to description of concrete configurations and operations of preferred embodiments of the present invention, shading which occurs in an image captured by an image capturing apparatus using an image sensor such as a digital camera will be described.

Shading is a phenomenon that a pixel value (light amount) in a peripheral portion of an image decreases. Generally, shading does not occur in the center of an image (position corresponding to the optical axis of an image capturing optical system) and the light amount decrease ratio increases toward the periphery of an image. When the light amount decrease ratio is set as R, an ideal pixel value at which no shading occurs is set as V0, and an actual pixel value at which shading occurs is set as V1, the light amount decrease ratio R in the specification is expressed by the following equation (1). The light amount decrease ratio is a value peculiar to a pixel in an image.
R=(V0−V1)/V0 (1)
Shading is roughly divided into lens system shading and sensor system shading. The lens system shading is shading resulting from characteristics of an image capturing optical system (taking lens) and occurs also in a film camera which does not use the image sensor. On the other hand, the sensor system shading is shading resulting from characteristics of the image sensor and is a phenomenon peculiar to the image capturing apparatus using the image capturing sensor.
1-1. Lens System Shading

Representative causes of the lens system shading are “vignetting” and “cosine fourth law”.

The “vignetting” is a phenomenon which occurs due to the fact that a part of an incident light beam is shielded by a frame for holding the image capturing optical system or the like. That is, the phenomenon corresponds to a phenomenon that the field of view is shielded by the frame of the image capturing optical system or the like when the user sees an object through the image capturing optical system obliquely with respect to the optical axis.

The “cosine fourth law” is a law such that the light amount of a light beam incident on the image capturing optical system at an inclination of an angle “a” from the optical axis of the image capturing optical system is smaller than that of a light beam which is incident in parallel with the optical axis by the fourth power of the cosine a The light amount decreases in accordance with the law.

The lens system shading corresponds to a phenomenon that the light amount decreases because of the characteristics of the image capturing optical system before a light beam reaches the image sensor and is not related with the characteristics of the image sensor.

1-2. Sensor System Shading

On the other hand, the sensor system shading corresponds to a phenomenon that the light amount decreases due to the characteristics of the image sensor after the light beam reaches the image sensor.

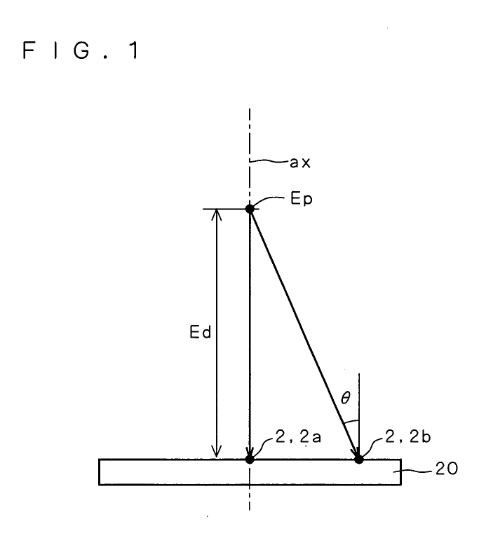

FIG. 1 is a diagram showing the relation between an image sensor 20 such as a CCD and the optical axis “ax” of an image capturing optical system. The upper side in the figure is a photosensitive face of the image sensor 20. In the photosensitive face, a plurality of fine light sensing pixels 2 are arranged two-dimensionally. On the optical axis “ax”, an exit pupil Ep of the image capturing optical system as a virtual image of the iris seen from an image side exists.

It can be regarded that a light beam is incident on each of the light sensing pixels 2 in the image sensor 20 from the position of the exit pupil Ep. Therefore, light is incident on a light sensing pixel 2a in the center of the image sensor 20 along the optical axis “ax” whereas light is incident on a light sensing pixel 2b in a peripheral portion of the image sensor 20 with an inclination from the optical axis “ax”. The incident angle θ of light increases toward the periphery of the image sensor 20 (that is, as the image height increases). When the distance from the image sensor 20 to the exit pupil Ep is set as “exit pupil distance” Ed, the incident angle θ of light depends on the exit pupil distance Ed and increases as the exit pupil distance Ed is shortened. The sensor system shading occurs due to the fact that light is obliquely incident on the light sensing pixel 2.

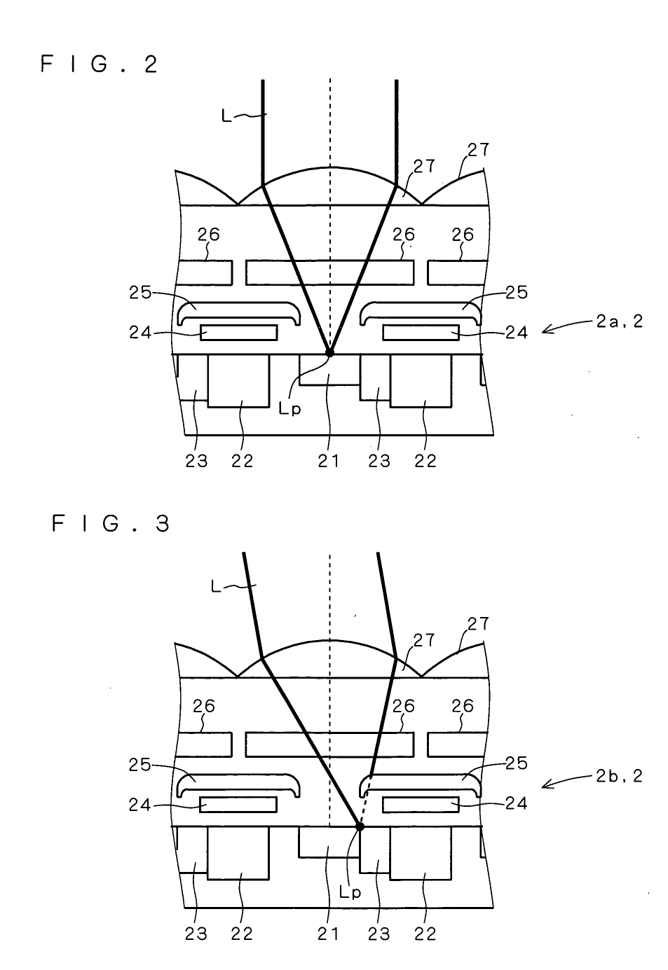

FIGS. 2 and 3 are cross-sectional views each showing a portion around the light sensing pixel 2 in the image sensor 20. FIG. 2 shows the light sensing pixel 2a in the center of the image sensor 20, and FIG. 3 shows the light sensing pixel 2b in a peripheral portion. On the light sensing pixels 2 in the image sensor 20 shown in the figures, light enters from the above. As understood by comparing the figures, the structure of the light sensing pixel 2 in the center and that in the peripheral portion of the image sensor 20 are the same.

Specifically, the light sensing pixel 2 has a photodiode 21 for generating and storing a signal charge according to the light reception amount. A channel 23 is provided next to the photodiode 21, and a vertical transfer part 22 for transferring signal charges is disposed next to the channel 23. Above the vertical transfer part 22 in the figure, a transfer electrode 24 for applying a voltage for transferring signal charges to the vertical transfer part 22 is provided. Above the transfer electrode 24, a light shielding film 25 made of aluminum or the like for shielding incoming light to the portion other than the photodiode 21 is disposed.

The foregoing configuration is formed for each light sensing pixel 2. Therefore, in the photosensitive face of the image sensor 20, configurations each identical to the foregoing configuration are disposed continuously with one another. As shown in the figure, the photodiode 21 receives light passed through a window formed between the neighboring two light shielding films 25.

For each of the light sensing pixels 2, a microlens 27 as a condenser lens for condensing light is disposed. In the examples of FIGS. 2 and 3, the microlens 27 is disposed just above the photodiode 21. That is, the center position of the microlens 27 and that of a photosensitive face of the photodiode 21 match with each other in the horizontal direction of the figure.

A color filter 26 for passing only light having a predetermined wavelength band is disposed between the microlens 27 and the photodiode 21. Color filters 26 for a plurality of colors are prepared and the color filter 26 of any one of the colors is disposed for each light sensing pixel 2.

As described above, light L is incident on the light sensing pixel 2a in the center of the image sensor 20 in parallel with the optical axis. As shown in FIG. 2, a light condensing position Lp by the microlens 27 matches the center position of the photosensitive face of the photodiode 21. In contrast, the light L is incident on the light sensing pixel 2b in the peripheral portion of the image sensor 20 with inclination from the optical axis. Consequently, as shown in FIG. 3, the light condensing position Lp is deviated from the center position of the photosensitive face of the photodiode 21 and a phenomenon occurs such that a part of the light is shielded by the light shielding film 25. As a result, in the light sensing pixel 2b in the periphery portion, the light reception amount of the photodiode 21 decreases.

The sensor system shading occurs on the above-described principle mainly. The rate of occurrence of a deviation of the light condensing position Lp and shielding of light by the light shielding film 25 increases as the incident angle θ of the light L increases. Therefore, toward the periphery of the image sensor 20 or the shorter the exit pupil distance Ed is, the light amount decrease ratio by the sensor system shading increases.

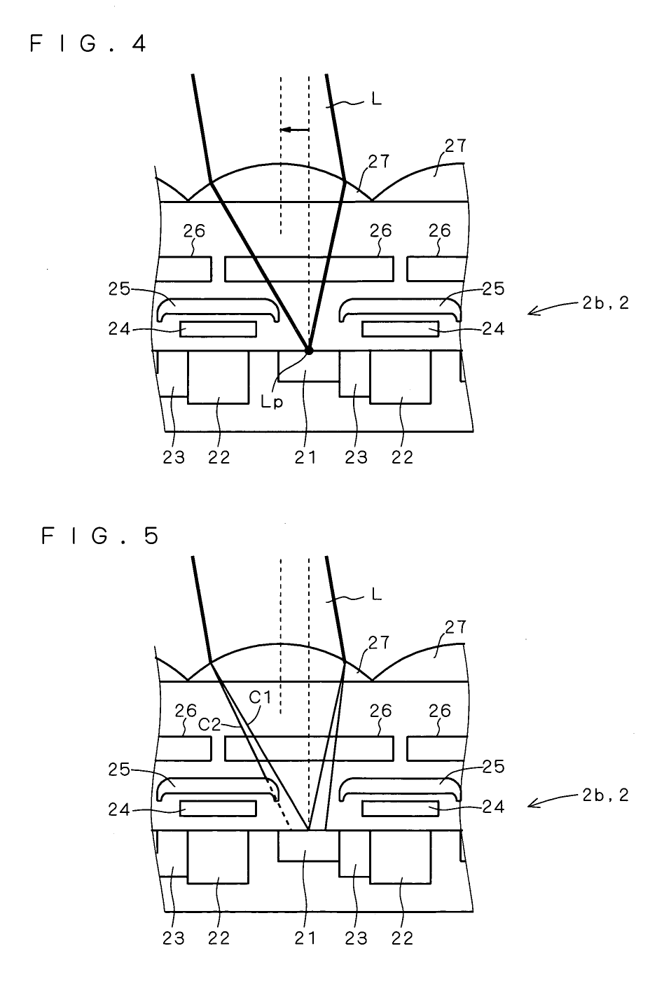

In recent years, to suppress the sensor system shading, as shown in FIG. 4, a technique of disposing the microlens 27 closer to the optical axis side of the image capturing operation system, not just above the photodiode 21, is applied to the image sensor 20. By the technique, also in the light sensing pixel 2b in the peripheral portion of the image sensor 20, as shown in the figure, the light condensing position Lp is adjusted so as to be on the photosensitive face of the photodiode 21, and the light reception amount of the photodiode 21 is prevented from decreasing.

However, even when such a technique is applied, the incident angle θ changes according to the exit pupil distance Ed as described above. Therefore, according to the exit pupil distance Ed, the sensor system shading still occurs in an image.

Since the sensor system shading occurs on the above-described principle, the light amount decrease ratio is directly influenced by the structure state such as layout of the components of the image sensor 20. Therefore, based on a manufacture error and the like of the image sensor 20, the light amount decrease ratio becomes asymmetric with respect to the center of an image (the position corresponding to the optical axis of the image capturing optical system). In recent years, the number of light sensing pixels to be provided for the image sensor is increasing dramatically. With the increase, the size of each light sensing pixel is being reduced. Consequently, the influence of a manufacture error of the image sensor exerted on the light amount decrease ratio of the sensor system shading is becoming higher.

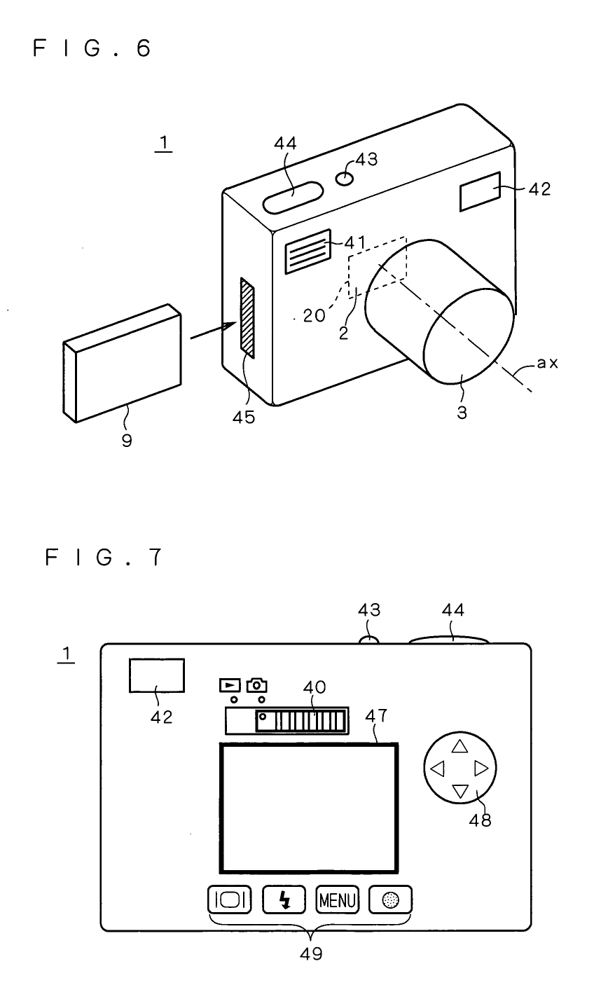

The light amount decrease ratio of the sensor system shading varies from color to color. As shown in FIG. 5, the light L entering the microlens 27 is deflected by the microlens 27 and condensed. Since dispersion (a phenomenon that light travels in different directions in accordance with wavelengths of the light due to variations of the refractive index for the wavelengths) occurs in the microlens 27, the condensing position or the like varies according to the wavelength. Therefore, as shown in FIG. 5, a phenomenon occurs such that light C1 having a wavelength of a certain color is condensed on the photosensitive face of the photodiode 21 and light C2 having a wavelength of another color is not condensed on the photosensitive face of the photodiode 21 or is shielded by the light shielding film 25. Therefore, even when the light sensing pixels 2 exist almost in the same positions, their light amount decrease ratios are different from each other according to the colors of the color filters 26 disposed. Due to the variations of the light amount decrease ratio among colors, a phenomenon that a color which does not exist in reality is generated in an image occurs (hereinafter, referred to as “color shading”). The intensity of the color shading also increases toward the periphery of an image.

1-3. Summary of Shading

In short, the sensor system shading has the following characteristics:
the light amount decrease ratio is asymmetrical with respect to the center of an image,
the light amount decrease ratio varies according to a color component, and
the light amount decrease ratio changes according to the exit pupil distance.

On the other hand, the lens system shading has the following characteristics:
the light amount decrease ratio is point-symmetrical with respect to the center of an image,
the light amount decrease ratio does not vary according to a color component, and
the light amount decrease ratio changes according to optical characteristic values (representatively, focal length, aperture value and focus lens position) determining the characteristics of the image capturing optical system.

In an image capturing apparatus described below, proper shading correction is made in consideration of the characteristics of both the sensor system shading and the lens system shading. In the following, a digital camera as an example of the image capturing apparatus using the image sensor will be described.

2. First Preferred Embodiment

2-1. Configuration

FIG. 6 is a perspective view showing a digital camera 1. FIG. 7 is a diagram showing the configuration on the rear side of the digital camera 1. The digital camera 1 has the functions of capturing an image of a subject and correcting shading in the captured image.

As shown in FIG. 6, on the front side of the digital camera 1, a electronic flash 41, an objective window of an optical viewfinder 42, and a taking lens 3 as an image capturing optical system having a plurality of lens units are provided. In a proper position in the digital camera 1 as a position of incident light passed through the taking lens 3, the image sensor 20 for capturing an image is provided. The photosensitive face of the image sensor 20 is disposed so as to be orthogonal to the optical axis “ax” of the taking lens 3 and so that its center matches the optical axis “ax”.

In the photosensitive face of the image sensor 20, a plurality of light sensing pixels 2 for photoelectrically converting a light image formed by the taking lens 3 are arranged two-dimensionally. Each of the light sensing pixels 2 of the image sensor 20 has the same configuration as that shown in FIG. 2. The image sensor 20 has a plurality of microlenses 27 and a plurality of color filters 26. In a manner similar to FIG. 2, the microlenses 27 and color filters 26 are disposed in correspondence with the light sensing pixels 2. The color filters 26 corresponding to three colors of, for example, R, G and B are employed. With the configuration, the image sensor 20 captures an image of three color components of R, G and B. To the light sensing pixels 2 of the peripheral portion in the image sensor 20, in a manner similar to FIG. 4, the technique of disposing the microlenses 27 on the optical axis “ax” side is applied.

On the top face side of the digital camera 1, a shutter start button 44 for accepting an image capture instruction from the user and a main switch 43 for switching on/off of the power are disposed.

In a side face of the digital camera 1, a card slot 45 into which a memory card 9 as a recording medium can be inserted is formed. An image captured by the digital camera 1 is recorded on the memory card 9. The recording image can be also transferred to an external computer via the memory card 9.

As shown in FIG. 7, on the rear side of the digital camera 1, an eyepiece window of the optical viewfinder 42, a mode switching lever 46 for switching the operation mode, a liquid crystal monitor 47 for performing various displays, a cross key 48 for accepting various input operations from the user, and a function button group 49 are provided.

The digital camera 1 has two operation modes of an “image capturing mode” for capturing an image and a “playback mode” for playing back the image. The operation modes can be switched by sliding the mode switching lever 46.

The liquid crystal monitor 47 performs various displays such as display of a setting menu and display of an image in the “playback mode”. In an image capturing standby state of the “image capturing mode”, a live view indicative of an almost real-time state of the subject is displayed on the liquid crystal monitor 47. The liquid crystal monitor 47 is used also as a viewfinder for performing framing.

Functions are dynamically assigned in accordance with the operation state of the digital camera 1 to the cross key 48 and the function button group 49. For example, when the cross key 48 is operated in the image capturing standby state of the “image capturing mode”, the magnification of the taking lens 3 is changed.

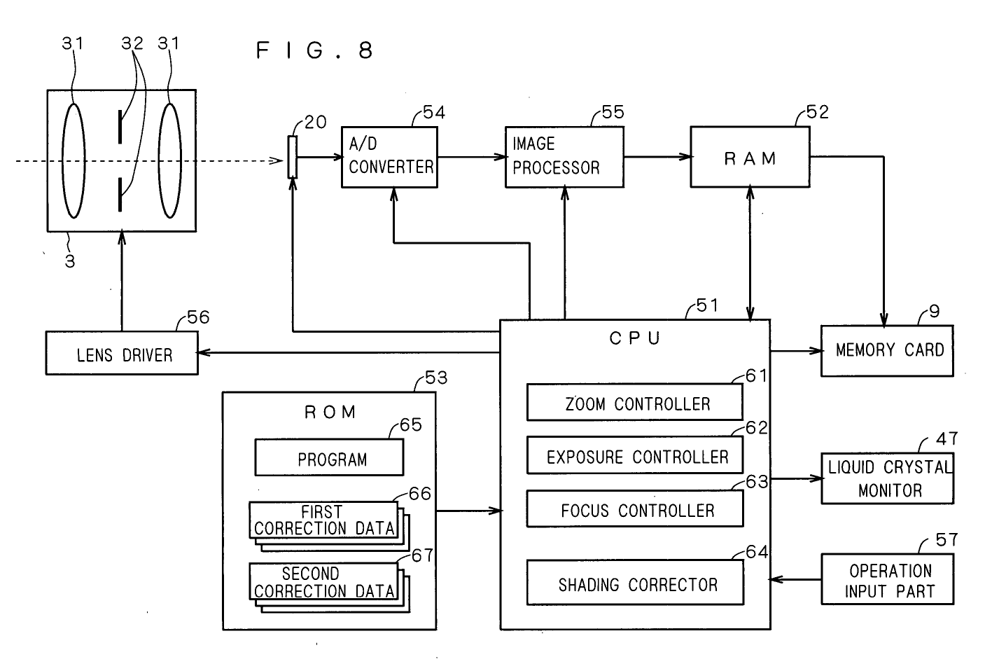

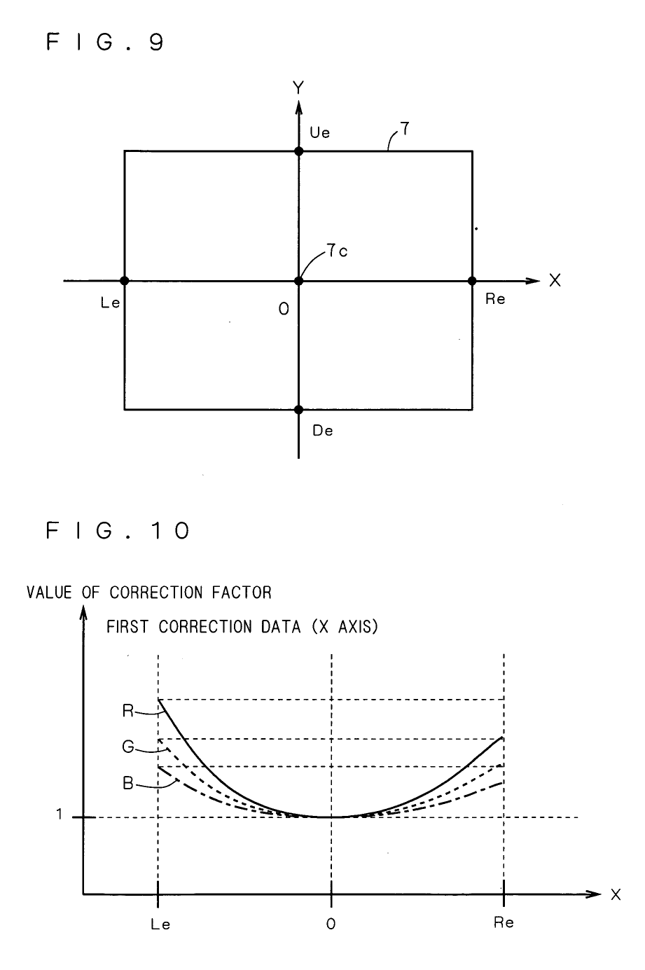

FIG. 8 is a block diagram schematically showing the main function configuration of the digital camera 1.

As shown in the diagram, a microcomputer for controlling the whole apparatus in a centralized manner is provided in the digital camera 1. Concretely, the digital camera 1 has a CPU 51 for performing various computing processes, an RAM 52 used as a work area of computation, and a ROM 53 for storing a program 65 and various data. The components of the digital camera 1 are electrically connected to the CPU 51 and operate under control of the CPU 51.

The taking lens 3, the image sensor 20, an A/D converter 54, an image processor 55, the RAM 52, and the CPU 51 in the configuration shown in FIG. 8 realize functions for capturing an image of the subject. Specifically, incident light through the taking lens 3 is received by the image sensor 20. In each of the light sensing pixels 2 in the image sensor 20, an analog electric signal according to the light reception amount is generated and is converted to a digital signal by the A/D converter 54. An image as a signal sequence of the digital electric signals is subjected to a predetermined process in the image processor 55 and the processed image is stored in the RAM 52. The image stored in the RAM 52 is subjected to predetermined processes including shading correction by the CPU 51 and the processed image as an image file is recorded in the memory card 9.

The image processor 55 performs various imaging processes such as γ correcting process and color interpolating process on an image output from the A/D converter 54. By the process of the image processor 55, a color image in which pixels have three pixel values of three color components is generated. It can be regarded that such a color image is formed by three color component images of an R-component image, a G-component image, and a B-component image.

When a lens driver 56 drives the lens group 31 included in the taking lens 3 and the iris 32 on the basis of a signal from the CPU 51, thereby changing the layout of the lens group 31 and the numerical aperture of the iris 32. The lens group 31 includes a zoom lens specifying the focal length of the taking lens 3 and a focus lens for changing the focus state of a light image. The lenses are also driven by the lens driver 56.

The liquid crystal monitor 47 is electrically connected to the CPU 51 and performs various displays on the basis of a signal from the CPU 51. An operation input part 57 is expressed as a function block of operation members including the shutter start button 44, mode switching lever 46, cross key 48, and function button group 49. When the operation input part 57 is operated, a signal indicative of an instruction related to the operation is generated and supplied to the CPU 51.

Various functions of the CPU 51 are realized by software in accordance with the program 65 stored in the ROM 53. More concretely, the CPU 51 performs the computing process in accordance with the program 65 while using the RAM 52, thereby realizing the various functions. The program 65 is pre-stored in the ROM 53. A new program can be obtained later by being read from the memory card 9 in which the program is recorded and stored into the ROM 53. In FIG. 8, a zoom controller 61, an exposure controller 62, a focus controller 63, and a shading corrector 64 schematically show a part of the functions of the CPU 51 realized by software.

The zoom controller 61 is a function for adjusting the focal length (magnification) of the taking lens 3 by changing the position of the zoom lens. The zoom controller 61 determines the position of the zoom lens to be moved on the basis of an operation on the cross key 48 of the user, transmits a signal to the lens driver 56, and moves the zoom lens to the position.

The exposure controller 62 is a function of adjusting brightness of an image captured. The exposure controller 62 sets exposure values (exposure time, an aperture value, and the like) with reference to a predetermined program chart on the basis of brightness of the image captured in the image capturing standby state. The exposure controller 62 sends a signal to the image sensor 20 and the lens driver 56 so as to achieve the exposure values. By the operation, the numerical aperture of the iris 32 is adjusted in accordance with the set aperture value and exposure for the exposure time which is set in the image sensor 20 is performed.

The focus controller 63 is an auto focus control function of adjusting a focus state of a light image by changing the position of the focus lens. The focus controller 63 derives the position of the focus lens where focus is achieved most on the basis of evaluation values of images sequentially captured with time and transmits a signal to the lens driver 56 to move the focus lens.

The shading corrector 64 is a function of correcting shading in a color image stored in the RAM 52 after process of the image processor 55. The shading corrector 64 makes shading correction by using correction data stored in the ROM 53.

2-2. Correction Data

Correction data used for shading correction will now be described. In the preferred embodiment, as correction data used for shading correction, first correction data 66 and second correction data 67 exist. The first correction data 66 is correction data for correcting the sensor system shading. The second correction data 67 is correction data for correcting the lens system shading.

FIG. 9 is a diagram showing an example of an image to be subjected to the shading correction. As shown in the diagram, an image 7 has a rectangular shape and is constructed by a plurality of pixels arranged two-dimensionally in the horizontal direction (lateral direction) and the vertical direction (longitudinal direction). A pixel in the center 7c of the image 7 is a light sensing pixel on which light along the optical axis of the taking lens 3 is incident. Consequently, the center 7c of the image 7 is the position corresponding to the optical axis of the taking lens 3.

Since the shading is a phenomenon that a pixel value in an image decreases, correction can be made by multiplying the pixel value of each of the pixels in the image 7 as shown in FIG. 9 with a correction factor based on the light amount decrease ratio peculiar to the pixel. When the value of the correction factor is set as K, the value K of the correction factor can be expressed by the following equation (2) using the light amount decrease ratio R.
K=1/(1−R) (2)
Such a correction factor is preliminarily obtained by measurement or the like and included in the first and second correction data 66 and 67. However, the correction factors corresponding to all of pixels of the image 7 are not included but correction factors corresponding to only some pixels are included. At the time of shading correction, the correction factors corresponding to the other pixels which are not included in the first and second correction data 66 and 67 are derived by computation (the details will be described later).

Concretely, the first and second correction data 66 and 67 include correction factors corresponding to only pixels existing in positions of the coordinate axes of the coordinate system which is set for an image to be corrected. In the digital camera 1, as shown in FIG. 9, a rectangular coordinate system using the center 7c as the origin O, using a straight line passing the origin O and extending in the horizontal direction as an X axis, and using a straight line extending in the vertical direction as a Y axis is set for the image 7. The position of each of pixels of the image 7 is expressed by a coordinate position in the coordinate system. Correction factors corresponding only to pixels existing on the two coordinate axes are included in the first and second correction data 66 and 67. In the following, correction factors related to only the positions on the coordinate axes will be called “axial factors” and a group of “axial factors” used under the same conditions will be called an “axial factor group”.

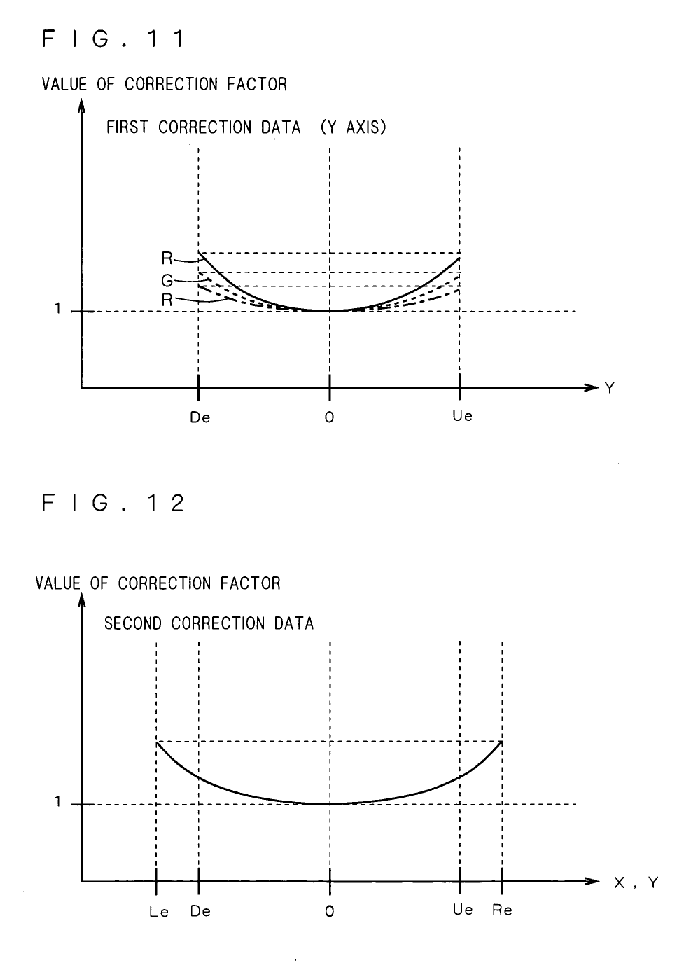

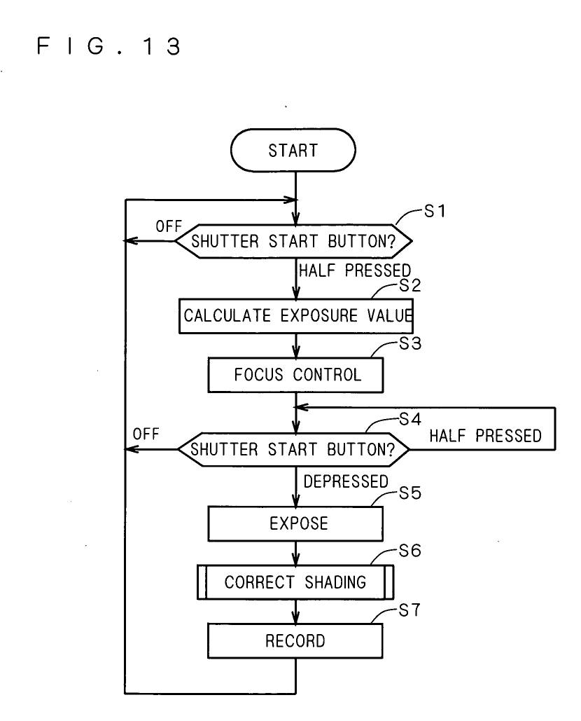

FIGS. 10 and 11 are diagrams showing examples of values of the axial factors (correction factors) included in the first correction data 66. FIG. 10 shows values corresponding to the pixels on the X axis, and FIG. 11 shows values corresponding to the pixels on the Y axis. FIG. 12 shows an example of values of axial factors included in the second correction data 67 and shows values corresponding to the pixels on both of the X and Y axes. The reference characters Le, Re, Ue and De shown in FIGS. 10 to 12 indicate the positions of the left end and the right end on the X axis of the image 7 and the upper end and the lower end on the Y axis of the image 7, respectively (see FIG. 9).

Shading in an image does not occur in the origin O (=the center of the image=the position corresponding to the optical axis of the image capturing optical system), and the light amount decrease ratio increases toward the periphery of an image. Consequently, as shown in FIGS. 10 to 12, in both of the first and second correction data 66 and 67, the value of the axial factor corresponding to the origin O of the image is “1” and increases toward the periphery of the image.

As described above, the light amount decrease ratio of the sensor system shading is characterized by being “asymmetric with respect to the origin O”. Therefore, as shown in FIGS. 10 and 11, the values of axial factors of the first correction data 66 for correcting the sensor system shading are asymmetric with respect to the origin O. The values of the axial factors on the X axis and those of the axial factors on the Y axis are different from each other even when the values are axial factors corresponding to pixels of the same image height.

The light amount decrease ratio of the sensor system shading is characterized by being “varied according to a color component”. Three pixel values indicated by one pixel decrease at different light amount decrease ratios. Consequently, as shown in FIGS. 10 and 11, the first correction data 66 includes the axial factors corresponding to the three color components of R, G and B. Therefore, the first correction data 66 includes six kinds of axial factor groups of 2(X and Y axes)×3 (R, G, B).

The light amount decrease ratio of the lens system shading is characterized by being “point symmetrical with respect to the origin O”. Therefore, the same axial factor for correcting the lens system shading can be used for the X and Y axes. Since the light amount decrease ratio of the lens system shading “does not vary according to a color component”, the common axial factor can be used for the three color components of R, G and B. Therefore, as shown in FIG. 12, the second correction data 67 includes only one kind of axial factor group and the values of the axial factors are symmetrical with respect to the origin O.

The light amount decrease ratio of the sensor system shading is characterized by “changing according to the exit pupil distance”. Consequently, a plurality of pieces of the first correction data 66 according to the exit pupil distance of the taking lens 3 are stored in the ROM 53 in the digital camera 1. For example, when the digital camera 1 recognizes the exit pupil distance in 10 levels, ten kinds of first correction data 66 which are different from each other are stored in the ROM 53. Each of the ten kinds of the first correction data 66 includes six kinds of axial factor groups.

On the other hand, the light amount decrease ratio of the lens system shading is characterized by “changing according to the focal length, aperture value, and focus lens position determining the characteristics of the taking lens”. In the ROM 53 of the digital camera 1, therefore, a plurality of pieces of the second correction data 67 according to the focus length, aperture value, and focus lens position are stored in the ROM 53 of the digital camera 1. For example, when the digital camera 1 recognizes each of the focal length, aperture value, and focus lens position in five levels, the second correction data 67 of 125 kinds (=5×5×5) is stored in the ROM 53. Each of the 125 kinds of second correction data 67 includes one kind of the axial factor group.

2-3. Basic Operation

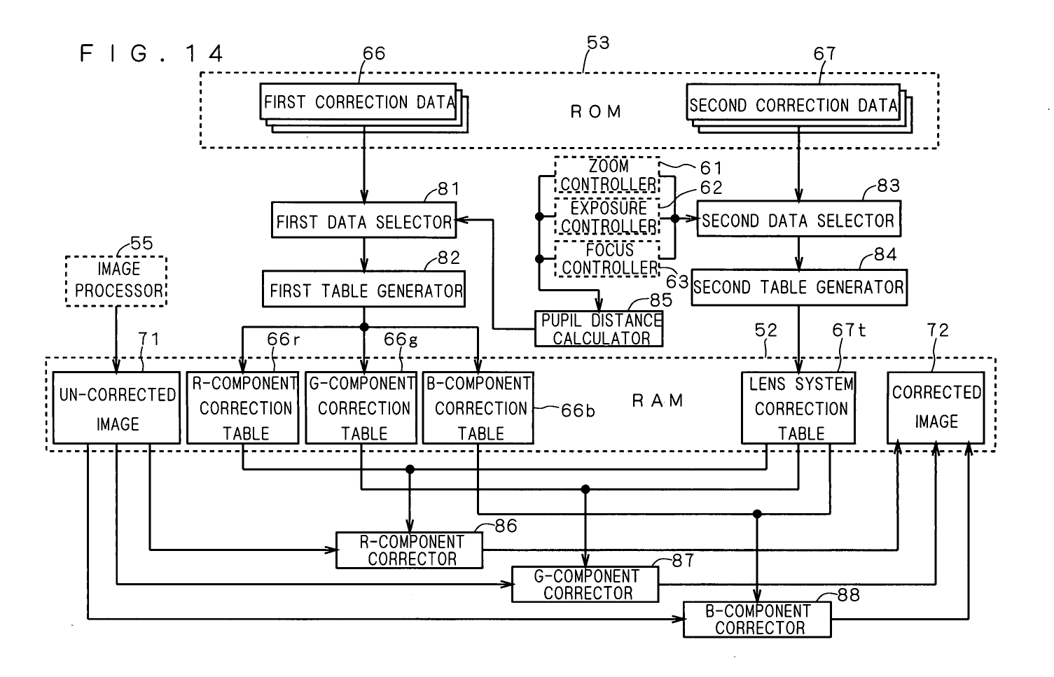

The operation in the image capturing mode of the digital camera 1 will now be described. FIG. 13 is a diagram showing the flow of basic operations in the image capturing mode of the digital camera 1.

When the operation mode is set to the image capturing mode, first, the digital camera 1 enters an image capturing standby state in which the digital camera 1 waits for an operation on the shutter start button 44, and a live view is displayed on the liquid crystal monitor 47 (step S1). When the cross key 48 is operated by the user in the image capturing standby state, the position of the zoom lens is moved by control of the zoom controller 61 and the focal length of the taking lens 3 is changed.

When the shutter start button 44 is half-pressed (“half-press” in step S1), in response to this, exposure values (exposure time and an aperture value) are set by the exposure controller 62. The numerical aperture of the iris 32 is adjusted according to the set aperture value (step S2). Subsequently, auto-focus control is executed by the focus controller 63 and the focus lens is moved to the position where focus is achieved most (step S3).

After the auto-focus control, the digital camera 1 waits for depression of the shutter start button 44 (step S4). This state is maintained while the shutter start button 44 is half-depressed. In the case where the operation of the shutter start button 44 is cancelled in this state (“OFF” in step S4), the process returns to step S1.

When the shutter start button 44 is depressed (“depress” in step S4), in response to this, exposure is made by the image sensor 20 in accordance with the set exposure time, and an image is captured. The captured image is subjected to predetermined processes in the A/D converter 54 and the image processor 55, thereby obtaining a color image in which each pixel has three pixel values corresponding to three color components. The color image is stored in the RAM 52 (step S5).

Subsequently, shading correction is made on the color image stored in the RAM 52 by the shading corrector 64 (step S6). After the shading correcting process, the image is converted to an image file in the Exif (Exchangeable Image File Format) by the control of the CPU 51 and the image file is recorded in the memory card 9. The image file includes tag information. As the tag information, identification information of the digital camera 1 and optical characteristics values such as focal length, aperture value, and focus lens position as image capturing parameters are written (step S7). After the image is recorded, the process returns to step S1.

2-4. Shading Correction

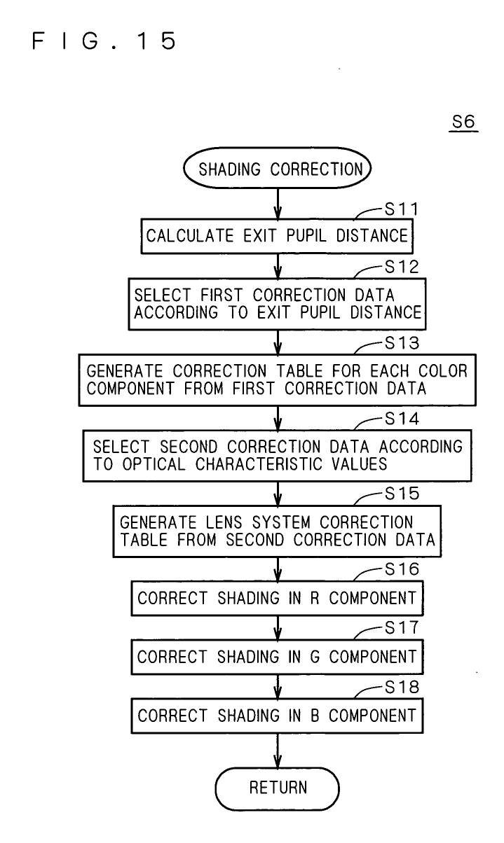

The shading correcting process (step S6) performed by the shading corrector 64 will now be described in detail. FIG. 14 is a diagram showing the functions related to the shading correcting process of the digital camera 1. FIG. 15 is a diagram showing the flow of the shading correcting process. In the configuration shown in FIG. 14, a first data selector 81, a first table generator 82, a second data selector 83, a second table generator 84, a pupil distance calculator 85, an R-component corrector 86, a G-component corrector 87, and a B-component corrector 88 are functions of the shading corrector 64. With reference to the figures, the shading correcting process will be described below. A color image to be subjected to shading correction, which is output from the image processor 55 and stored in the RAM 52 will be called an “un-corrected image” 71.

First, exit pupil distance of the taking lens 3 at the time point the un-corrected image 71 is captured is calculated by the pupil distance calculator 85. The exit pupil distance can be calculated on the basis of the focal length, aperture value, and focus lens position. The focal length, aperture value, and focus lens position are input from the zoom controller 61, exposure controller 62, and focus controller 63, respectively, to the pupil distance calculator 85. By substituting the values for a predetermined arithmetic expression, the exit pupil distance is calculated (step S11).

On the basis of the calculated exit pupil distance, the first correction data 66 is selected by the first data selector 81. As described above, the plurality of pieces of first correction data 66 are stored in the ROM 53. One piece according to the actual exit pupil distance of the taking lens 3 is selected from the plurality of pieces of first correction data 66 (step S12).

Next, correction tables 66r, 66g and 66b each in a table form are generated by the first table generator 82 from the selected first correction data 66. Specifically, correction factors corresponding to all of pixels of the un-corrected image 71 are derived from the axial factors included in the first correction data 66, and the correction tables 66r, 66g and 66b including the derived correction factors are generated.

In the correction tables 66r, 66g and 66b, the correction factors corresponding to all of the pixels of the un-corrected image 71 are included in a two-dimensional orthogonal array which is the same as that of the pixels of the un-corrected image 71. The position of each of the correction factors of the correction tables 66r, 66g and 66b is also expressed by a coordinate position in an XY coordinate system (see FIG. 9) similar to that of the pixels of the un-corrected image 71. Therefore, the pixel and the correction factor in the same coordinate position correspond to each other.

From the first correction data 66, three correction tables corresponding to the three color components of R, G and B, to be specific, the R-component correction table 66r, G-component correction table 66g, and B-component correction table 66b are generated. More concretely, the R-component correction table 66r is generated from two axial factor groups of the X and Y axes related to the R components out of the six kinds of axial factor groups included in one piece of the first correction data 66. Similarly, the G-component correction table 66g is generated from the two axial factor groups of the X and Y axes related to the G, components, and the B-component correction table 66b is generated from the two axial factor groups of the X and Y axes related to the B components.

The value of each of the correction factors in the correction table is derived by referring to the values of the axial factors in the two axial factor groups of the X and Y axes on the basis of the coordinate position. For example, when the coordinate position in the XY coordinate system is expressed as (X, Y), the value of the correction factor of (X, Y)=(a, b) is derived by multiplication of the value of the axial factor of X=a in the axial factor group related to the X axis and the value of the axial factor of Y=b in the axial factor group related to the Y axis.

The generated R-component correction table 66r includes the correction factor for correcting the sensor system shading in an R-component image in the un-corrected image 71. Similarly, the G-component correction table 66g includes a correction factor for correcting the sensor system shading in a G-component image. The B-component correction table 66b includes a correction factor for correcting the sensor system shading in a B-component image. The values of the correction factors of the correction tables 66r, 66g, and 66b are asymmetrical with respect to the origin O. The generated correction tables 66r, 66g, and 66b are stored in the RAM 52 (step S13).

The second correction data 67 is selected by the second data selector 83 on the basis of the optical characteristic values at the time point when the un-corrected image 71 is captured. As described above, the plurality of pieces of second correction data 67 are stored in the ROM 53. One piece of data according to the three optical characteristic values of the focal length, aperture value, and focus lens position is selected from the plurality of pieces of second correction data 67. The focal length, aperture value, and focus lens position are input from the zoom controller 61, exposure controller 62, and focus controller 63, respectively, to the second data selector 83 and, on the basis of the values, the second correction data 67 is selected (step S114).

From the selected second correction data 67, a lens system correction table 67t is generated by the second table generator 84. Specifically, correction factors related to all of the pixels of the un-corrected image 71 are derived from the axial factors included in the second correction data 67, and the lens system correction table 67t including the derived correction factors is generated. The lens system correction table 67t is in the same data format as that of the correction tables 66r, 66g and 66b, and the position of each of the correction factors of the lens system correction table 67t is expressed by the coordinate position in the XY coordinate system.

The value of each of the correction factors of the lens system correction table 67t is also derived on the basis of the coordinate position. One of the axial factor groups (see FIG. 12) included in the second correction data 67 is used as the axial factor group indicative of axial factors of both the X and Y axes. The generated lens system correction table 67t includes a correction factor for correcting the lens system shading in the un-corrected image 71, and the values of correction factors are point symmetrical with respect to the origin O. The generated lens system correction table 67t is stored in the RAM 52 (step S15).

After the four correction tables 66r, 66g, 66b and 67t are generated, by using the four correction tables 66r, 66g, 66b and 67t, shading in the un-corrected image 71 is corrected. At the time of the shading correction, different correction tables for three color component images forming the un-corrected image 71 are used.

First, shading correction is made on the R-component image by the R-component corrector 86 by using the R-component correction table 66r and the lens system correction table 67t. Concretely, each of the pixel values of the R-component image is multiplied with a corresponding correction factor in the R-component correction table 66r, thereby correcting the sensor system shading in the R-component image. Further, each of the pixel values of the R-component image is multiplied with the corresponding correction factor in the lens system correction table 67t, thereby correcting the lens system shading in the R-component image. It is also possible to multiply each of the pixel values of the R-component image with the result obtained by multiplying the correction factor in the R-component correction table 66r with the correction factor in the lens system correction table 67t (step S16).

Similarly, shading in the G-component image is corrected by the G-component corrector 87 by using the G-component correction table 66g and the lens system correction table 67t (step S17). Further, shading in the B-component image is corrected by the B-component corrector 88 by using the B-component correction table 66b and the lens system correction table 67t (step S18). By the R-component image, G-component image, and B-component image corrected individually, a corrected image 72 is formed as a result of the shading correction performed on the un-corrected image 71.

Since the lens system shading does not differ among color components, shading correction is made by using the same lens system correction table 67t to all of the color component images, thereby properly correcting the lens system shading in the un-corrected image 71. On the other hand, the sensor system shading varies according to a color component. Shading correction is made by using the correction tables 66r, 66g and 66b dedicated to the R-component, G-component and B-component images, respectively. Consequently, the sensor system shading in the un-corrected image 71 is also properly corrected. That is, both of the lens system shading and the sensor system shading in the un-corrected image 71 can be properly corrected. Therefore, an influence of all of shadings including the color shading can be properly eliminated in the corrected image 72.

As described above in the first preferred embodiment, in the digital camera 1, shading correction is made by using a correction factor in consideration of the characteristics of both the lens system shading and sensor system shading.

Concretely, the light amount decrease ratio of the sensor system shading is asymmetrical with respect to the origin O, so that shading correction is made by using a correction table including the correction factors which are asymmetrical with respect to the origin O. Since the light amount decrease ratio of the sensor system shading varies according to a color component, a correction table is prepared in accordance with the color component image, and shading correction is made by using a correction table corresponding to the color component image. On the other hand, the light amount decrease ratio of the lens system shading is point symmetrical with respect to the origin O and does not vary according to a color component. Consequently, shading correction is made by commonly using a correction table including correction factors which are point symmetrical with respect to the origin O for three color-component images. In such a manner, shading in an image including color shading can be properly corrected.

Since the light amount decrease ratio of the sensor system shading changes according to the exit pupil distance, the first correction data 66 including the correction factor according to the actual exit pupil distance is selectively used from a plurality of candidates. On the other hand, the light amount decrease ratio of the lens system shading changes according to the optical characteristic values (focal length, aperture value, and focus lens position), so that the second correction data 67 including the correction factor according to the actual optical characteristic value is selectively used from a plurality of candidates. Thus, shading in an image can be corrected more properly.

In the digital camera 1, correction factors for all of pixels are not stored but axial factors related to only the positions of the coordinate axes in the coordinate system which is set for an image are stored. From the axial factors, correction factors corresponding to a plurality of pixels are derived. Therefore, as compared with the case where all of correction factors corresponding to the plurality of pixels are stored as the first correction data 66 in the ROM 53, the amount of data to be stored can be made smaller.

3. Second Preferred Embodiment

A second preferred embodiment of the present invention will now be described. Since the configuration and operation of the digital camera 1 of the second preferred embodiment are similar to those of the first preferred embodiment, the points different from the first preferred embodiment will be described.

As described above, the light amount decrease ratio of the sensor system shading is asymmetrical with respect to the origin O of an image. However, the asymmetry of the light amount decrease ratio in the vertical direction (Y axis direction) of an image is smaller than that of the light amount decrease ratio in the horizontal direction (X axis direction) for the following reason. Since the photosensitive face of the photodiode 21 of the light sensing pixel 2 in the vertical direction is longer than that in the horizontal direction, the allowable manufacturing tolerance of the image sensor 20 in the vertical direction is wide.

Therefore, when the light amount decrease ratio of the sensor system shading is regarded as symmetrical with respect to the origin O in the vertical direction of an image and shading correction is made by using a correction table of which correction factor values are asymmetrical in the horizontal direction and symmetrical in the vertical direction, sensor system shading can be corrected almost properly.

In the digital camera 1 of the second preferred embodiment, to correct the sensor system shading by using the principle, a correction table of which correction factor values are asymmetrical in the X axis direction and are symmetrical in the Y axis direction is used.

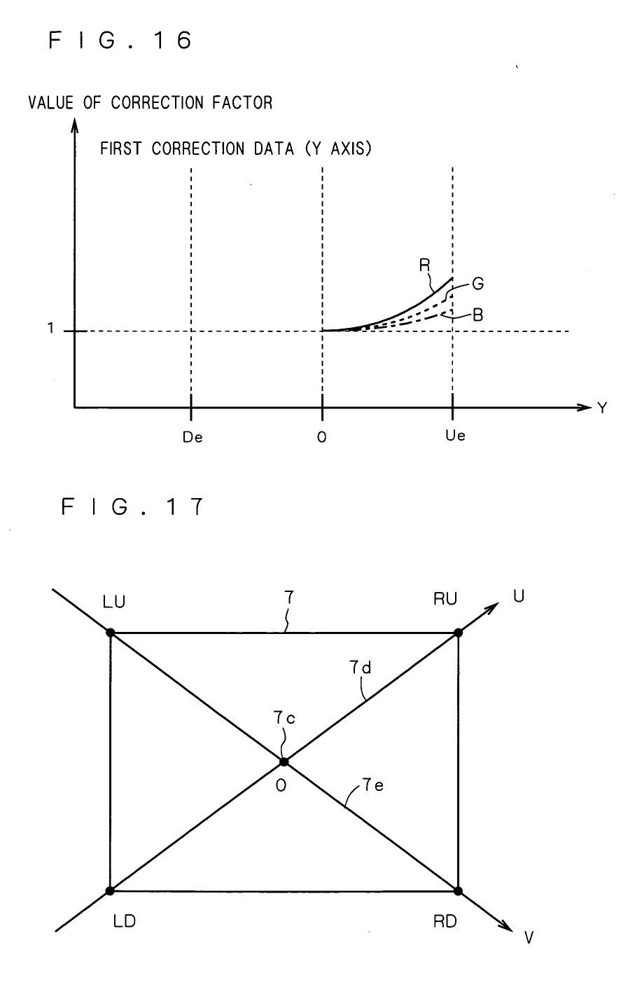

FIG. 16 is a diagram showing an example of values of the axial factors corresponding to pixels on the Y axis included in the first correction data 66 in the second preferred embodiment. As shown in FIG. 16, the first correction data 66 includes three axial factor groups corresponding to the three color components of R, G and B in a manner similar to the first preferred embodiment. In the axial factor groups, only the axial factors corresponding to the pixels on the positive side of the origin O in the Y axis direction are included but axial factors corresponding to pixels on the negative side in the Y axis direction are not included. This is because the values of the correction factors of the correction table for correcting sensor system shading are symmetrical with respect to the origin O in the Y axis direction.

At the time of using the first correction data 66 for shading correction, as values of the axial factors on the negative side in the Y axis direction, the values of the axial factors on the positive side in coordinate positions obtained by inverting the sign (positive or negative sign) of the Y coordinate are used. For example, as the value of the axial factor of Y=−b, the value of the axial factor of Y=b is used. In such a manner, a correction table of which correction factor value is asymmetric in the X axis direction and symmetrical in the Y axis direction is generated.

As described above, in the digital camera 1 of the second preferred embodiment, the first correction data 66 includes values on only one side of the origin as the axial factors related to the Y axis, so that the data amount of the first correction data 66 is reduced. Therefore, the amount of data to be stored in the ROM 53 as the first correction data 66 can be reduced. Although only the axial factors corresponding to the pixels on the positive side in the Y axis direction from the origin O are included in the example of FIG. 16, only axial factors corresponding to the pixels on the negative side in the Y axis direction of the origin O may be included.

4. Third Preferred Embodiment

A third preferred embodiment of the present invention will now be described. Since the configuration and operation of the digital camera 1 of the third preferred embodiment are similar to those of the first preferred embodiment, the points different from the first preferred embodiment will be described.

Although the rectangular coordinate system is employed as a coordinate system set for an image to be shading-corrected in the foregoing preferred embodiments, an oblique coordinate system is employed in the third preferred embodiment. Concretely, as shown in FIG. 17, an oblique coordinate system using the center 7c of the image 7 as the origin O and using two diagonal lines 7d and 7e of the image 7 as coordinate axes (U axis and V axis), respectively is set for the image 7.

Also in the case of employing such an oblique coordinate system, in a manner similar to the first preferred embodiment, shading in an image can be properly corrected. To be specific, axial factors as correction factors related only to the positions of the U and V axes are included in the first correction data 66 and the second correction data 67. By expressing the position of a correction factor in a correction table as the coordinate position in a similar oblique coordinate system, the values of correction factors can be derived by referring to the values of the two axial factors of the U and V axes on the basis of the coordinate position.

In the case where the oblique coordinate system is employed and the light amount decrease ratio of the sensor system shading is regarded as symmetrical with respect to the origin O in the vertical direction of an image in a manner similar to the second preferred embodiment, the axial factors of the first correction data 66 can be commonly used for the U and V axes.

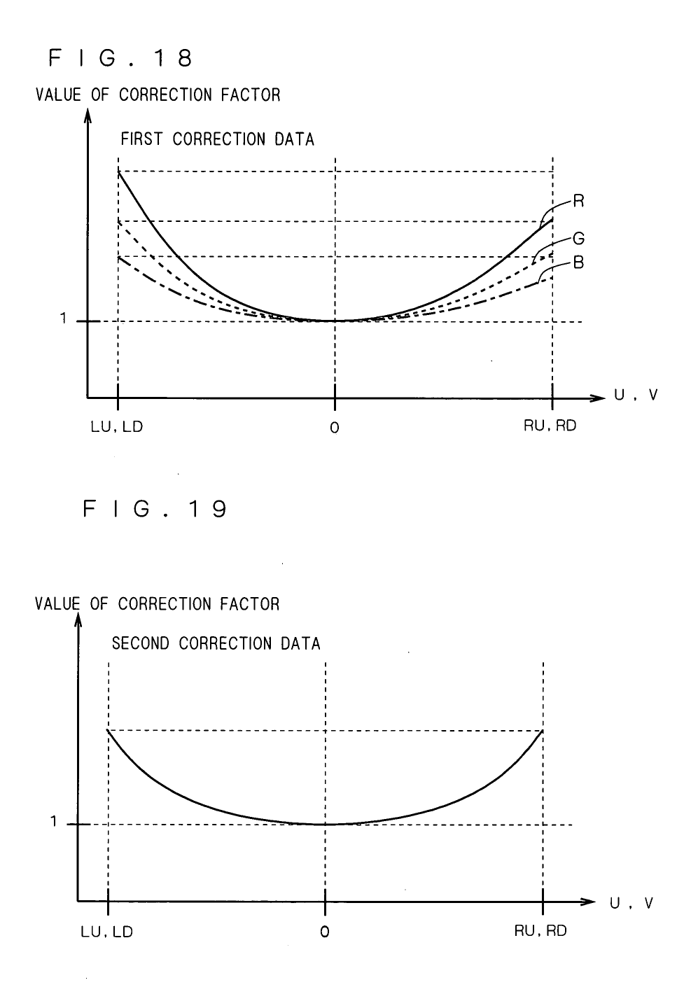

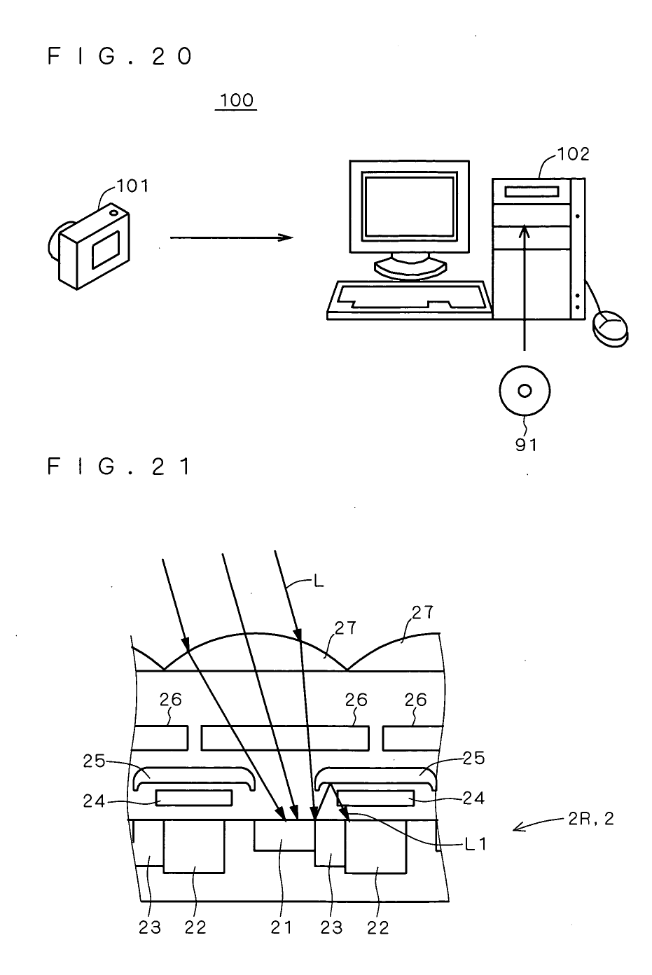

FIG. 18 is a diagram showing an example of values of axial factors included in the first correction data 66 in this case. FIG. 19 is a diagram showing an example of values of the axial factors included in the second correction data 67 in this case. In FIGS. 18 and 19, reference characters LU, LD, RU and RD indicate upper left, lower left, upper right, and lower right end positions in the image 7, respectively (see FIG. 17).

As shown in FIG. 18, the first correction data 66 includes, in a manner similar to the first preferred embodiment, axial factor groups corresponding to the three color components of R, G and B. The axial factors are commonly used for the U and V axes.

In this case, the light amount decrease ratio of the sensor system shading is regarded as symmetrical with respect to the origin O in the vertical direction of an image. Consequently, in shading correction, a correction table whose correction factor values are asymmetrical in the horizontal direction and symmetrical in the vertical direction is used. Therefore, a change in the value of the correction factor from the upper left to the lower right and a change in the value of the correction factor from the lower left to the upper right are the same. Thus, the axial factors of the first correction data 66 can be commonly used for the U and V axes.

The light amount decrease ratio of the lens system shading is point symmetrical with respect to the origin O. Therefore, as shown in FIG. 19, even in the case of employing the oblique coordinate system, only one axial factor group is included in the second correction data 67, and the values of axial factors are symmetrical with respect to the origin O.

As described above, since the digital camera 1 of the third preferred embodiment employs the oblique coordinate system, when the light amount decrease ratio of the sensor system shading is regarded as symmetrical with respect to the origin O in the vertical direction of an image, the axial factors can be shared by two coordinate axes. Thus, the amount of data to be stored in the ROM 53 as first correction data 66 can be reduced.

5. Fourth Preferred Embodiment

A fourth preferred embodiment of the present invention will now be described. Although shading in an image is corrected in the digital camera 1 in the foregoing preferred embodiments, in the fourth preferred embodiment, shading is corrected in a general computer.

FIG. 20 is a diagram showing an image processing system 100 including such a general computer. The image processing system 100 includes a digital camera 101 for capturing an image and a computer 102 for correcting shading in the image captured by the digital camera 101.

The digital camera 101 can have a configuration similar to that of the digital camera 1 of the foregoing preferred embodiments. The digital camera 101 captures a color image of the subject in a manner similar to the digital camera 1 of the foregoing preferred embodiments. The captured image is not subjected to shading correction but is recorded as it is as an image file of the Exif into the memory card 9. The image recorded in the memory card 9 is transferred to the computer 102 via the memory card 9, a dedicated communication cable, or an electric communication line.

The computer 102 is a general computer including a CPU, a ROM, a RAM, a hard disk, a display and a communication part. The CPU, ROM, RAM and the like in the computer 102 realize a function of correcting shading similar to that in the foregoing preferred embodiments. Specifically, the CPU, ROM, RAM and the like function like the shading correcting part shown in FIG. 8 (that is, the first data selector 81, first table generator 82, second data selector 83, second table generator 84, pupil distance calculator 85, R-component corrector 86, G-component corrector 87 and B-component corrector 88 shown in FIG. 14).

A program is installed into the computer 102 via a recording medium 91 such as a CD-ROM. The CPU, ROM, RAM and the like function according to the program, thereby realizing the function of correcting shading. That is, the general computer 102 functions as an image processing apparatus for correcting shading.

An image transferred from the digital camera 101 is stored into the hard disk of the computer 102. At the time of correcting shading, the image is read from the hard disk to the RAM and prepared so that shading can be corrected. Processes similar to those of FIG. 15 are performed in the computer 102 by the shading correcting function.

The optical characteristic values (focal length, aperture value, and focus lens position) necessary to calculate the exit pupil distance (step S11) and select the lens system shading (step S12) are obtained from tag information of the image file. The first correction data 66, second correction data 67, and data of arithmetic expressions and the like necessary to calculate the exit pupil distance are pre-stored in the hard disk of the computer 102. A plurality of kinds of the data may be stored in accordance with the kind of a digital camera. By using the data, the shading correction can be properly made on the image also in the general computer 102.

6. Modifications

The preferred embodiments of the present invention have been described above. The present invention is not limited to the foregoing preferred embodiments but may be variously modified.

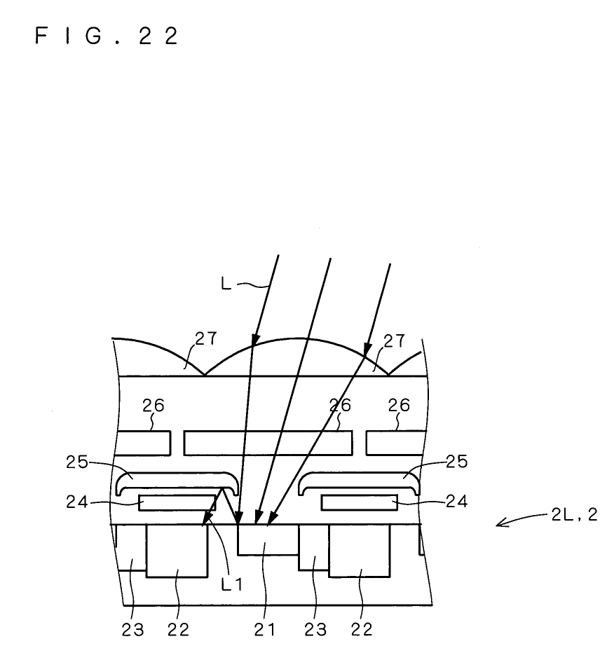

The first correction data 66 for correcting the sensor system shading may have a correction factor in which a false signal generated due to stray light in an image sensor is considered. The principle of generation of a false signal by stray light will be briefly described below with reference to FIGS. 21 and 22.

FIGS. 21 and 22 are cross-sectional views showing a portion around the light sensing pixel 2 in the peripheral portion of the image sensor 20. FIG. 21 shows a light sensing pixel 2R corresponding to a pixel in a right part of an image and FIG. 22 shows a light sensing pixel 2L corresponding to a pixel in a left part of the image. As understood from comparison of the diagrams, the structure of the light sensing pixels 2 of the image sensor 20 is the same irrespective of the position, and the vertical transfer part 22 is disposed on the same side (right side in the diagram) of the photodiode 21.

As described above, in the light sensing pixel 2 in the peripheral part of the image sensor 20, the light L is incident so as to be inclined from the optical axis. Consequently, a part of the light may be reflected by a neighboring member or the like deviated from the photosensitive face of the photodiode 21 and become stray light L1. The stray light L1 is reflected again by the light shielding film 25 and enters the vertical transfer part 22, thereby generating a false signal. Due to the false signal, the pixel value in an image fluctuates.

Since the stray light L1 is generated when the light L enters with inclination from the optical axis, the fluctuation value of the pixel value due to the false signal increases toward the periphery of the image. The stray light L1 enters the vertical transfer part 22 for transferring signal charges of the light sensing pixel 2R on the right side as shown in FIG. 21. In the light sensing pixel 2L on the left side, as shown in FIG. 22, the stray light L1 enters the vertical transfer part 22 for transferring signal charges of the neighboring light sensing pixel. Therefore, the fluctuation value of the pixel value due to the false signal becomes asymmetrical in the horizontal direction with respect to the center of an image.

That is, the fluctuation value of the pixel value due to the false signal increases toward the periphery of an image and is asymmetrical in the horizontal direction in the image. Therefore, fluctuations of the pixel value caused by the false signal have characteristics similar to those of the sensor system shading, so that they can be corrected in a manner similar to the sensor system shading. By making the correction factors in which the fluctuations of the pixel value caused by the false signal are considered included in the first correction data 66, the fluctuations of the pixel value caused by the false signal can be also corrected properly.

Although the second correction data 67 has the axial factors in both of the directions with respect to the origin O as a reference in the first preferred embodiment, since the light amount decrease ratio of the lens system shading is point symmetrical, the second correction data 67 may include the axial factors only on one side of the origin O as a reference. It is sufficient to calculate the axial factors on the other side of the origin O in a manner similar to the second preferred embodiment.

Although the second correction data 67 is selected on the basis of three optical characteristic values of the focal length, aperture value, and focus lens position in the foregoing preferred embodiments, the second correction data 67 may be selected on the basis of two of the optical characteristic values or one optical characteristic value.

Although it has been described in the foregoing preferred embodiments that the various functions are realized when the CPU performs computing processes in accordance with a program, all or part of the various functions may be also realized by dedicated electric circuits. Particularly, by constructing a part for repeating computation by a logic circuit, high-speed computation is realized. On the contrary, all or part of the functions realized by the electric circuits may be realized when the CPU performs computation processes in accordance with the program.

Although the digital camera 1 has been described as an example in the foregoing preferred embodiments, the technique according to the present invention can be applied to any image capturing apparatus as long as the apparatus captures an image by using the image sensor.

While the invention has been shown and described in detail, the foregoing description is in all aspects illustrative and not restrictive. It is therefore understood that numerous modifications and variations can be devised without departing from the scope of the invention.

1. An image capturing apparatus comprising:
an image capturing optical system;
an image sensor having a plurality of light sensing pixels for photoelectrically converting a light image formed by said image capturing optical system; and
a corrector for correcting shading in an image made of a plurality of pixels in a two-dimensional array captured by said image sensor by using a plurality of correction factors corresponding to said plurality of pixels, wherein
values of said plurality of correction factors are asymmetrical with respect to a position corresponding to an optical axis of said image capturing optical system.

2. The image capturing apparatus according to claim 1, wherein
said corrector makes said shading correction by using first correction data including a correction factor for correcting shading which occurs due to characteristics of said image sensor.

3. The image capturing apparatus according to claim 2, wherein
said corrector selectively uses correction data according to exit pupil distance of said image capturing optical system from a plurality of candidates of said first correction data.

4. The image capturing apparatus according to claim 2, wherein
said corrector makes said shading correction by also using second correction data including a correction factor for correcting shading which occurs due to characteristics of said image capturing optical system.

5. The image capturing apparatus according to claim 4, wherein
said corrector selectively uses correction data according to optical characteristics of said image capturing optical system from a plurality of candidates of said second correction data.

6. The image capturing apparatus according to claim 5, wherein
said optical characteristics include at least one of a focal length, an aperture value and a focus lens position of said image capturing optical system.

7. The image capturing apparatus according to claim 2, wherein
said first correction data includes a correction factor according to a false signal generated due to stray light in said image sensor.

8. The image capturing apparatus according to claim 1, further comprising:
a memory for storing axial factors as correction factors related to positions of a coordinate axis in a coordinate system set for said image, wherein
a plurality of correction factors corresponding to said plurality of pixels, respectively, are obtained from said axial factors stored in said memory.

9. The image capturing apparatus according to claim 8, wherein
said coordinate system includes a rectangular coordinate system using a position corresponding to an optical axis of said image capturing optical system as an origin and using two straight lines passing said origin and extending in two arrangement directions of said plurality of pixels as said coordinate axes.

10. The image capturing apparatus according to claim 9, wherein
said memory stores only correction factors on one side of said origin with respect to correction factors related to positions of a predetermined coordinate axis among said axial factors.

11. The image capturing apparatus according to claim 8, wherein
said coordinate system includes an oblique coordinate system using two diagonal lines of said image as said coordinate axes.

12. The image capturing apparatus according to claim 1, wherein
said image sensor has a plurality of color filters disposed in correspondence with said plurality of light sensing pixels, and
said corrector makes said shading correction by using different correction factors for a plurality of color component images captured by said image sensor.

13. The image capturing apparatus according to claim 1, wherein
said image sensor further includes a plurality of condenser lenses disposed in correspondence with said plurality of light sensing pixels.

14. A method for correcting shading in an image capturing apparatus, comprising the steps of:
preparing an image made of a plurality of pixels arranged in a two-dimensional array, captured by an image sensor having a plurality of light sensing pixels for photoelectrically converting a light image formed by an image capturing optical system; and
correcting shading in said image by using a plurality of correction factors which correspond to said plurality of pixels and are asymmetrical with respect to the position corresponding to an optical axis of said image capturing optical system.

15. A computer-readable computer program product for making a computer execute the following processes of:
preparing an image made of a plurality of pixels arranged in a two-dimensional array, captured by an image sensor having a plurality of light sensing pixels for photoelectrically converting a light image formed by an image capturing optical system; and
correcting shading in said image by using a plurality of correction factors which correspond to said plurality of pixels and are asymmetrical with respect to the position corresponding to an optical axis of said image capturing optical system.
